(19) United States
(12) Patent Application Publication
(10) Pub. No.: US 2007/0175989 A1
(43) Pub. Date: Aug. 2, 2007

(54) Interactive communication system for remotely providing product information

(75) Inventor: Jean-Marc Auger, Sainte-Julie (CA)

Correspondence Address: BCF LLP, 1100 RENE'-LE'VESQUE BLVD. WEST, 25TH FLOOR, MONTREAL, QC, H3B-5C9, CA

(73) Assignee: SUNRISE TRADEX CORP., Saint-Mathieu-de-Beloeil (CA)

(21) Appl. No.: 11/525,208

(22) Filed: Sep. 22, 2006

Related U.S. Application Data
(60) Provisional application No. 60/719,223, filed on Sep. 22, 2005.

(51) Int. Cl. G06K 15/00

(52) U.S. Cl. 235/383

(57) ABSTRACT

An interactive product information device is disclosed for establishing a communication link between a customer using the device and a product representative at a remote location. The interactive product information device, to be used in various commercial settings such as stores, shopping malls, trade shows and the like, is designed to establish a communication link between the customer and the product representative upon activation of the device by the customer. This activation, which may be implemented through a single one-touch activation switch and corresponding circuit, operates a communication device connected thereto and automatically establishes the link. The same one-touch activation switch may also be used to activate a product demonstration unit provided with the product information the device.

### FIELD OF THE INVENTION

The invention relates to product information systems and, more particularly, to an interactive communication system for remotely providing product information to potential buyers interested in a product.

### BACKGROUND OF THE INVENTION

In a commercial setting, such as in a store, a shopping mall or again at various trade shows, product information is commonly provided to potential buyers interested in a given product through various audio and visual means ranging from product displays and information charts, distributed product pamphlets and advertisements, various in-store commercials and advertisements, and the like. To obtain further information, a customer can then potentially request the help of a sales or product representative which may guide the customer through the finer details of the product in question.

One particular drawback of these methods of product information distribution resides in the frequent unavailability of such sales or product representatives, or again, the unavailability of a product representative sufficiently knowledgeable with regards to the product in question to provide satisfactory product information to the customer. For example, a customer browsing for a new home air conditioning system at a home renovation center may not have access to product or sales representatives sufficiently knowledgeable in such systems to obtain the necessary product information required to make a proper selection and purchase. In fact, it is not uncommon for a customer to remain unattended for a long period of time before finally getting the attention of a sales representative, such representative often having limited experience with the product of interest.

Consequently, a new product information system is needed to address the above drawbacks and other drawbacks of conventional methods of providing product information to potential customers.

### SUMMARY OF THE INVENTION

It is therefore an aim of the present invention to provide a product information device adapted to improve distribution and accessibility of product information to potential customers.

More specifically, in accordance with the present invention, there is provided an interactive product information device for establishing a communication link between a customer using the device and a product representative at a remote location, the interactive product information device comprising a display, a communication device and at least one activation switch, the activation switch provided at the display and electrically coupled to the communication device. The communication link is automatically established by an activation of the activation switch.

Also in accordance with the present invention, there is provided a method for remotely providing product information to a customer, the product information being provided by a product representative at a remote location, the method comprising the steps of:
a) providing a product information device comprising a communication device;
b) having the customer activate said product information device;
c) automatically establishing, upon activation by the customer of said product information device, a communication link between said communication device and the product representative; and
d) providing the product information over said communication link.

Still in accordance with the present invention, there is provided a one-touch activation circuit for an interactive product information device, the activation circuit adapted to operate a cellular telephone coupled thereto and automatically establish a wireless communication link between a customer using the product information device and a product representative at a remote location, the activation circuit comprising at least one timing circuit adapted to provide, upon application of an input voltage thereon, a pulsed output signal, said pulsed output signal providing an input signal to the cellular telephone, a timing of the pulsed output signal being adapted to correspond to about an input timing required to operate the cellular telephone and automatically establish the wireless communication link.

Other aims, objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a perspective view of an interactive product information device for remotely providing product information to a customer, in accordance with an illustrative embodiment of the present invention;

FIG. 2 is a diagram illustrating a plurality of interactive product information devices wirelessly communicating with a remote product information station over a wireless communication network, in accordance with the illustrative embodiment of FIG. 1;

FIG. 3 is a circuit diagram of an electric circuit configured to translate a one-touch activation of the interactive product information device into a two-pulse digital cellular phone activation signal to automatically establish a communication link between the product information device and the remote product information station in accordance with the illustrative embodiment FIG. 1;

FIG. 4 is a bottom plan view of a printed circuit board (PCB) and various electrical elements (phantom lines) mounted on a top face thereof, designed to implement the electric circuit of FIG. 3; and

FIG. 5 is a flow chart illustrating an exemplary operation of the interactive product information device of FIG. 1.

### DESCRIPTION OF ILLUSTRATIVE EMBODIMENTS

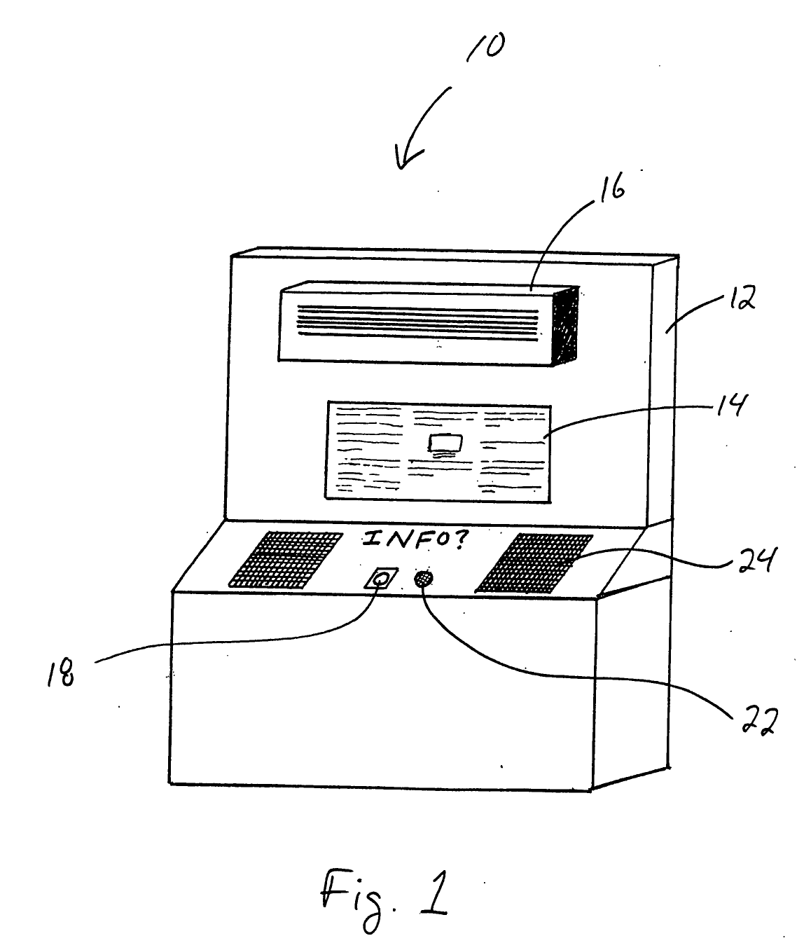

Referring to FIG. 1, and in accordance with an illustrative embodiment of the present invention, an interactive product information device, generally referred to using the numeral 10, will now be described. The product information device 10 is generally designed to provide a customer and potential buyer with information pertaining to a given product and/or service, a given series of products and/or services, or a general product and/or service chain offered by a given company, organization or distributor. Such a product information device may be installed in various venues, such as for example in a store, a shopping mall, various trade shows, and the like. In practice, a customer will be attracted to the product information device generally by interest in the marketed product(s) and/or service(s), or again by curiosity. In any case, the general purpose of the product information device is to draw attention from potential buyers and provide them with information that will encourage them to make a purchase or order various services marketed and publicized by the device.

To provide such information, the product information device 10 is generally comprised of a mounted display, as in 12, which may provide, for example, written information boards 14, access to various pamphlets and information cards (not shown), and other such written product and/or service information. The product information device may also comprise various product and/or service samples and/or demonstrators, as an air conditioner 16 (see example hereinbelow), to provide the customer with a preview of what may be expected from the marketed product(s) and/or service(s). Audio and visual aids and information packages may also be provided with the product information device 10 to supplement the shopping experience of the customer.

In the illustrative embodiment of FIG. 1, the product information device provides information on a series of air conditioners to be used in a home. To demonstrate the use of the marketed air conditioners, the air conditioner demonstration unit 16 is fitted to the display 12 and can be selectively activated by the customer, for instance, using a button 18 or and activation switch provisioned therefore. Upon activation of the demonstration unit 16, the customer experiences the function of the air conditioner and, if pleased, is provided with an additional incentive to make a purchase.

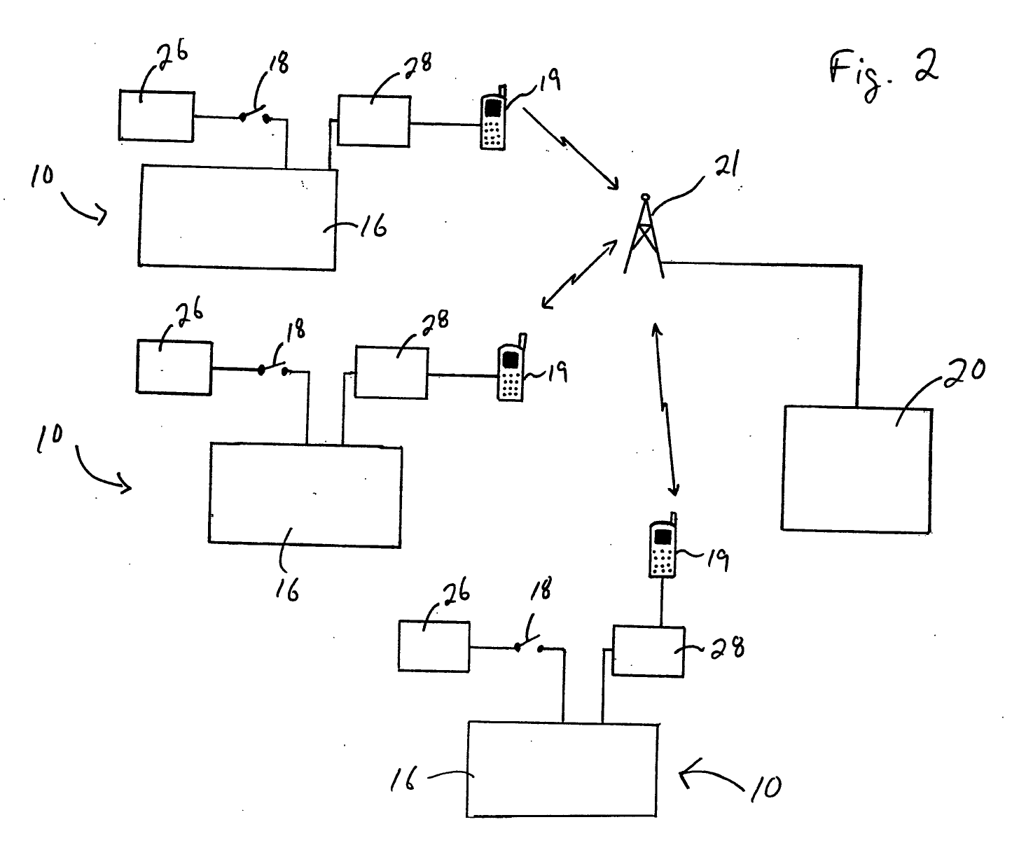

Referring now to FIGS. 1 and 2, the product information device 10 is also fitted with an interactive communication device 19, in this embodiment a pre-programmed cellular telephone, configured to provide the interested customer automatic access to a product or service representative, located remotely, in order to obtain further information. For instance, each product information device 10 is fitted with a respective cellular telephone 19 that is pre-programmed to communicate directly with a remote product information station 20. The remote product information station 20, which may be located locally within the geographic region of a given set of installed product information devices 10, or again located centrally to provide state, province or countrywide product information services, can accept calls from various product information devices 10 through conventional landline and/or wireless communication networks 21. In any case, a sales or product representative answering calls at the remote product information station 20 will be available to answer a customer's questions about the product(s) and/or service(s) offered by the company, manufacturer and/or distributor in question. To enhance communications between the customer and the remote sales representative, microphones and speakers, as in 22 and 24 respectively, may be fitted to the display 12 and connected to the cellular telephone 19.

In this illustrative embodiment, a communication link is established automatically between a given product information device's cellular telephone 19 and the remote product information station 20 upon activation of the demonstration unit 16. For instance, a one-touch activation of the product information device 10, again for instance using the activation button or switch 18, may both activate the demonstration unit 16 and establish a communication link with the remote product information station 20.

With particular reference to FIG. 2, the product information device 10 is generally comprised of one or plural power source(s) 26, namely a dedicated battery or a general power line connected to a conventional wall or floor power outlet, an activation switch, as in 18, a communication activation circuit 28 for operating the communication device 19 (i.e. cellular telephone) and automatically establishing the desired communication link with the remote station 20, and an optional demonstration unit, as in 16. Other features and components of the product information device 10, such as the microphones 22 and speakers 24 described hereinabove with reference to FIG. 1, are also coupled to the product information device 10 and powered, as needed, either directly or indirectly by the power source 26. Proper connections between the communication device 19, the microphone 22 and speakers 24 are also provided to enhance communications between the customer and the remote sales or product representative.

Referring back to FIGS. 1 and 2, the product information device 10 is configured to be operated from a single activation switch 18. For instance, when a customer presses button 18, represented in FIG. 2 by the switch of the same numeral, electrical power from the power source 26 is provided to both the demonstration unit 16 and the communication activation circuit 28. As such, the demonstration unit 16 is activated to provide the customer with a demonstration of the product's function and operation and, a direct communication link is established, through the communication device 19, to the remote product information station 20. In this embodiment, the communication activation circuit 28 is illustratively powered through an electrical circuitry of the demonstration unit 16. Other circuit connection means and configurations to obtain similar results should be apparent to a person of ordinary skill in the art and are not considered to extend the general scope and nature of the present disclosure.

In this illustrative embodiment, the communication link is established using a digital cellular telephone, as in 19, coupled to the product information device 10. In order to establish the communication link, the communication activation circuit 28 should relay appropriate activation signals to the cellular telephone 19 to implement a pre-programmed direct dial function thereon. For instance, on a great number of digital cellular telephones, two inputs are required to implement a call using a pre-programmed number stored in the phone's memory. In many cases, the user must press the ‘send’ button twice to activate the call, that is to first enter the stored numbers' list and then select and dial a number on the list. If the stored numbers' list only contains one number, which could be the case in this illustrative embodiment since only one call centre or remote product information station 20 is to be reached by any given cellular telephone 19, then a double activation of the ‘send’ function will automatically make a call to the selected remote product information station 20. To implement such a call with a single activation of the product information device 10, the communication activation circuit 28 should translate the one-touch activation generated by the customer using switch 18 into a two-pulse operation of the cellular telephone 19.

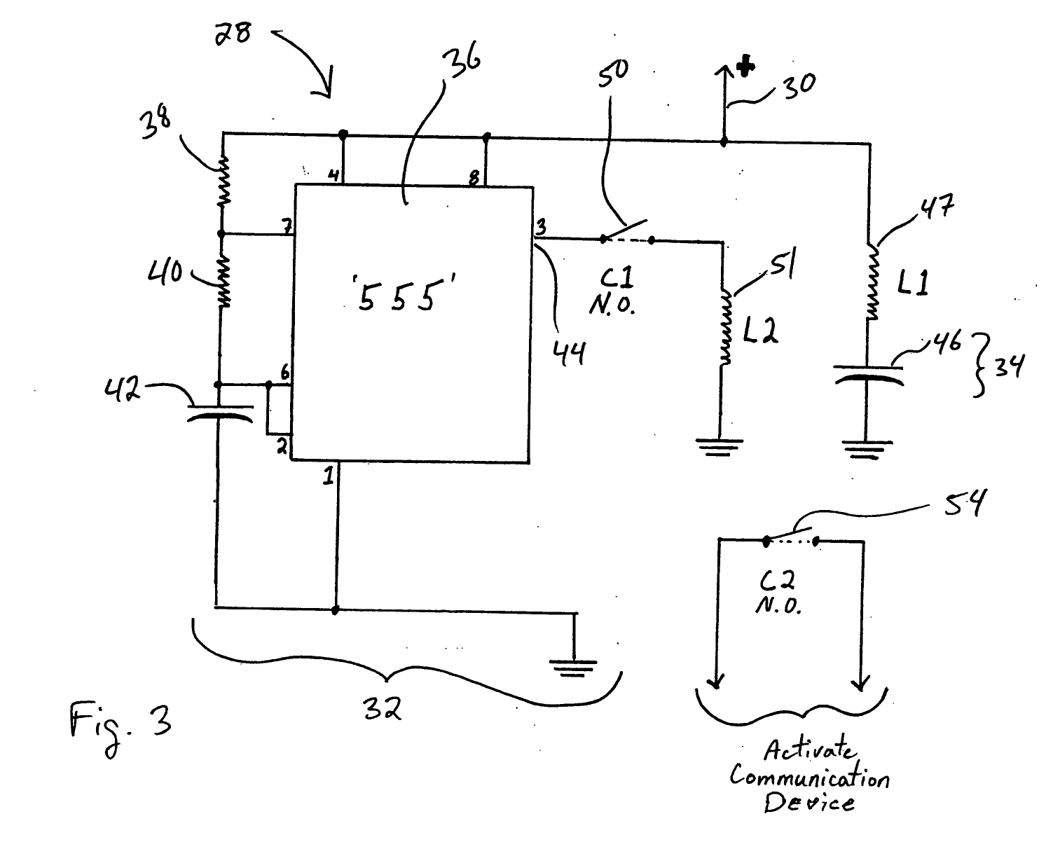

Referring now to FIG. 3, the communication activation circuit 28 is described in detail. FIG. 3 illustrates an exemplary activation circuit 28 that, under the application of an input voltage 30, automatically operates the cellular telephone 19 to establish a communication link between the product information device 10 and the remote product information station 20. In this illustrative embodiment, the input voltage 30 is provided and applied to the circuit 28 through the circuitry of the demonstration unit 16 upon activation of the activation switch 18 (FIG. 2). Note that, when inactive, the digital cellular telephone 19 may be kept in hands-free sleep mode to reduce power consumption.

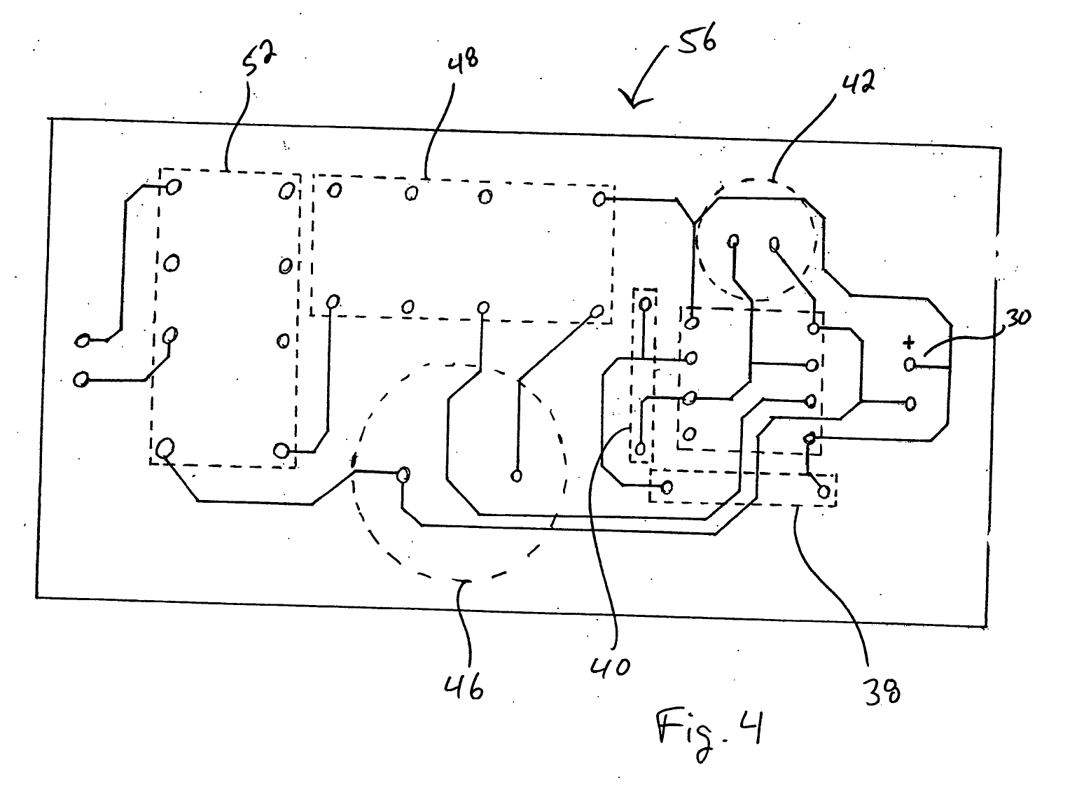

The circuit 28 is generally comprised of a timing circuit 32, to generate two activation pulses of appropriate timing to implement the call through the cellular telephone 19 and, a timing element 34 to restrain the communication activation circuit 28 to the generation of only two pulses. The timing circuit 32 is illustratively comprised of a ‘555’ integrated circuit chip 36, two resistors 38 and 40, and a capacitor 42. The chip 36 is configured to operate in a stable mode and thus to generate, upon application of an input voltage 30, a pulsed output signal at 44 governed by the respective characteristics of the resistors 38 and 40, and the capacitor 42. The timing element 34 is illustratively comprised of a single capacitor 46 mounted in series with a coil 47 (L1) of a first relay 48 (see FIG. 4) operating a normally open contact 50 (C1) therein. In practice, when an input voltage is applied to the circuit 28, the relay 48 closes the contact 50 until the capacitor 46 is fully charged, at which point current ceases to flow through the coil 47 and the contact 50 is reopened. When current is permitted to flow through the contact 50, that is when the output signal of the timing circuit 32 is permitted to flow through the first contact 50, a coil 51 (L2) of a second relay 52 (see FIG. 4) activates, in accordance with the pulsatile nature of the output signal, a second normally open contact 54 (C2) that ultimately activates the cellular telephone 19 and induces same to establish the desired communication link.

In one exemplary illustrative embodiment of the present invention, designed in particular to operate a digital cellular telephone by Nokia, model 3586I, the activation circuit 28 is configured to provide two consecutive activation pulses of about half a second (0.5 s) in approximately one second (1 s). To do so, the resistor 38 is selected to be approximately 33KΩ, the resistor 40 approximately 1KΩ, and the capacitor 42 approximately 22 μF. To interrupt the circuit 28 after the two required activation pulses have been generated, the capacitor 46 is selected to provide a capacitance of approximately 3300 μF. Using this selection of electrical elements with the input voltage 30, illustratively provided by the activated circuitry of the demonstration unit 16, of approximately 12V DC and of roughly 30% variance (roughly 9V DC to 16V DC), the desired cellular telephone operation sequence is accomplished.

Namely, upon activation of the product information device 10 using the one-touch activation switch 18, the input voltage 30 is applied to the communication activation circuit 28. As a result, a first current is directed through the first relay 48 (L1), which closes contact 50 (C1), and the capacitor 46 starts accumulating a charge. Simultaneously, a second current is directed through the timing circuit 32 to generate the pulsed output signal at 44, the output signal being defined by approximately half second (0.5 s) pulses at roughly 2 Hz. These output pulses are directed across the closed contact 50 (C1) and provide a pulsed activation of relay 52, which periodically closes contact 54 to provide the two activation pulses required to operate the cellular telephone and establish the desired communication link. This sequence produces a double sequential activation of the cellular telephone 19's ‘send’ function to automatically dial the phone number of the product information station 20 stored in the cellular telephone's memory. After a period of approximately one second (1 s), the capacitor 46 becomes fully charged and consequently interrupts the inflow of current thereto, thereby deactivating relay 48 (L1), reopening contact 50 (C1) and interrupting the transfer of pulsed output signals from the timing circuit 32 to the cellular telephone 19.

At this point, a communication link is established between the product information device 10 and the remote product information station 20. Simultaneously, the demonstration unit 16 may continue to operate for a predetermined period of time, at the end of which, the demonstration unit 16 is deactivated, the input voltage 30 applied to the communication activation circuit 28 is released and the capacitor 46 is discharged. When the activation switch or button 18 is reactivated, the activation process is reproduced; the demonstration unit 16 is restarted and a new communication link is established between the product information device 10 and the remote product information station 20.

Referring now to FIG. 4, an exemplary printed circuit board (PCB) 56 to implement the circuit 28, as described hereinabove, is presented. In this figure, a bottom plan view of the PCB 56 is provided illustrating in phantom lines the various electric components utilised in this illustrative embodiment to generate the required activation pulses. As will be apparent to a person of skill in the art, various other PCB 56 and component configurations may be used to obtain a similar result. Such variations are not considered to extend the general scope and nature of the present disclosure. For instance, the timing of the timing circuit's output pulses may be varied to accommodate other types of cellular telephones or other types of communication devices altogether. Various analogue cellular telephones, which only require single pulse activation of the ‘send’ function, could also be used in the present context by altering the timing element 34 to limit the activation signal to a single pulse. Further, different communication devices may require a different number of pulses or different pulse durations and/or frequencies. Modifications to the communication activation circuit 28 to operate these alternative communication devices should now be apparent to a person of skill in the art and are thus not considered to extend the general scope of the present disclosure.

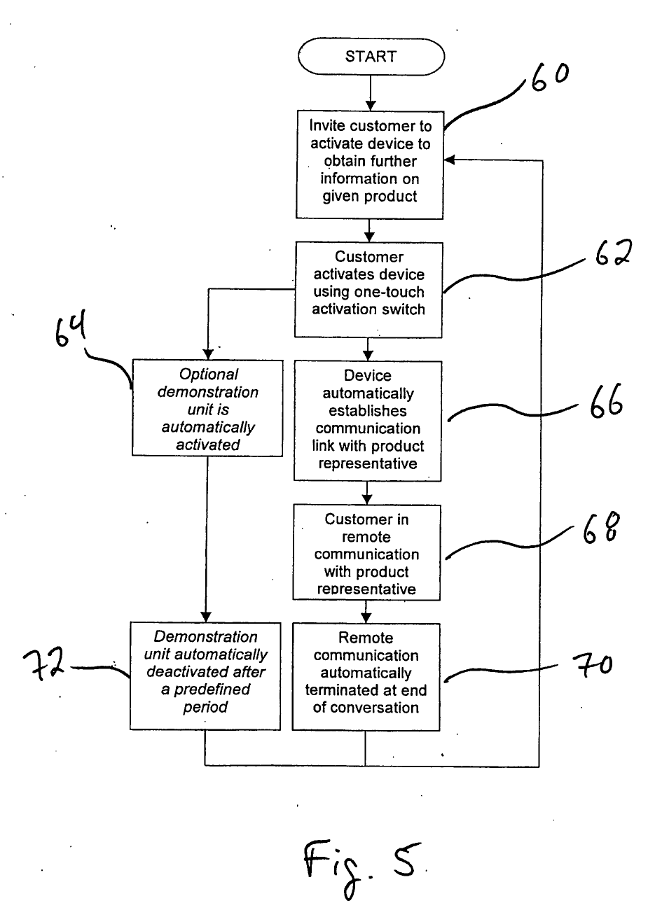

In FIG. 5, an exemplary flowchart is presented illustrating the general steps involved in the use and operation of the product information device 10. In a first step 60, a customer is invited to activate the device 10 to obtain further information on a given product. The customer activates the device 10 at step 62 using the one-touch activation switch or button 18 on the display 12. At steps 64 and 66 respectively, the optional demonstration unit 16 is activated and a communication link is established between the device 10 and the remote product information station 20. At step 68, the customer is in remote communication with a sales or product representative at the remote product information station 20. Upon completion of the conversation between the customer and the product or sales representative, the communication link is interrupted at step 70. After a predetermined period of time, the demonstration unit 16 is also automatically deactivated at step 72. The device 10 is then ready for reactivation, at which point the demonstration unit 16 can be restarted and a new communication link can be established between the device 10 and the product information station 20.

As discussed hereinabove, the product information device 10 allows an interested customer to obtain specialized information from a dedicated sales or product representative at the press of a button, as in 18. This system helps a service provider or company offer better customer service to potential buyers of their products and/or services. Further, by remotely linking plural product information devices 10 (see FIG. 2) to a same product information station 20, better customer support and management may be provided from a specialized team of representatives.

Various options may also be available in a system agglomerating plural product information devices 10. For instance, different product information devices, as in 10, may be used to promote and market different products and services, in which case, the communication device 19 of each device 10 could be pre-programmed to call a number selected in view of the marketed product and/or service. A network of such devices 10 could then be used throughout a given store or commercial venue, or again throughout various market chains and commercial establishments to simultaneously provide information to plural customers interested in different products and/or services. Ultimately, whether the device 10 is used to promote the sale of home air conditioning units, computers and peripherals, audio/video equipment, appliances, furniture, or any other type of consumable product, or again promote the sale of various types of packages and services such as home repair services, travel assistance services, and the like, a customer and potential buyer may access specialized information from a dedicated product and/or service representative at the press of a single button.

Also, though the above disclosure focuses on the use of cellular telephones to establish a remote communication link between the product information device 10 and the remote product information station 20, other communication devices and means may also be considered without extending the scope and nature of the present disclosure. For instance, other wireless communication devices may include, but are not limited too, data phones, hybrid personal digital assistants (hybrid PDAs), portable computers, handheld computers and the like. Also, programmable landline devices such as portable and desktop computers, telephones and the like may also be considered to provide similar services. Using the above and other such communication devices, a communication link between the product information device 10 and the remote product information station 20 may be implemented over various wireless and/or landline communication networks and be comprised of, for example, a wireless digital or analogue cellular communication link, a Voice over IP (VoIP) communication link, an Integrated Services Digital Network (ISDN) communication link, a Digital Subscriber Line (DSL) communication link, a wireless DSL communication link, a radio communication link, a Public Switched Telephone Network (PSTN) communication link and so on.

Furthermore, advanced landline and/or wireless communication systems may also provide the opportunity to implement audio/video links between the product information device 10 and the remote station 20. This additional feature would provide a visual contact between the customer and the product or sales representative, thereby enhancing the transfer of product and/or service information to the customer.

Although an illustrative embodiment of the invention has been described above, it should be understood that this description should not be interpreted in any limiting manner since many variations and refinements are possible without departing from the spirit of the invention. The scope of the invention will be defined in the annexed claims.

What is claimed is:

1. An interactive product information device for establishing a communication link between a customer using the device and a product representative at a remote location, the interactive product information device comprising a display, a communication device and at least one activation switch, said activation switch provided at said display and electrically coupled to said communication device, wherein the communication link is automatically established by an activation of said activation switch.

2. The interactive product information device as claimed in claim 1, wherein said activation switch comprises a one-touch activation switch.

3. The interactive product information device as claimed in claim 2, the interactive product information device further comprising a product demonstration unit, said product demonstration unit also being activated by said one-touch activation switch.

4. The interactive product information device as claimed in claim 1, wherein said communication device is a wireless communication device.

5. The interactive product information device as claimed in claim 4, wherein said wireless communication device comprises at least one of a digital cellular telephone, an analogue cellular telephone, a data phone, a hybrid PDA, a portable laptop computer and a handheld computer.

6. The interactive product information device as claimed in claim 1, wherein said communication link comprises at least one of a wireless cellular link, a VoIP link, an ISDN communication link, a DSL link, a wireless DSL link, a radio link and a PSTN link.

7. A method for remotely providing product information to a customer, the product information being provided by a product representative at a remote location, the method comprising the steps of:
a) providing a product information device comprising a communication device;
b) having the customer activate said product information device;
c) automatically establishing, upon activation by the customer of said product information device, a communication link between said communication device and the product representative; and
d) providing the product information over said communication link.

8. The method as claimed in claim 7, wherein said communication link is established over at least one of a wireless cellular link, a VoIP link, an ISDN communication link, a DSL link, a wireless DSL link, a radio link and a PSTN link.

9. The method as claimed in claim 7, wherein said activation of said product information device is provided by an activation of a one-touch activation switch.

10. A one-touch activation circuit for an interactive product information device, the activation circuit adapted to operate a cellular telephone coupled thereto and automatically establish a wireless communication link between a customer using the product information device and a product representative at a remote location, the activation circuit comprising at least one timing circuit adapted to provide, upon application of an input voltage thereon, a pulsed output signal, said pulsed output signal providing an input signal to the cellular telephone, a timing of said pulsed output signal adapted to correspond to about an input timing required to operate the cellular telephone and automatically establish the wireless communication link.

11. The one-touch activation circuit as claimed in claim 10, the one-touch activation circuit further comprising a circuit timing element, said timing element adapted to limit a duration of said pulsed output signal to a predetermined number of pulses, said predetermined number of pulses coinciding with an input number of pulses required to operate the cellular telephone and automatically establish the wireless communication link.

12. The one-touch activation circuit as claimed in claim 11, wherein the cellular telephone comprises a digital cellular telephone, said timing element being adapted to limit said duration of said pulsed output signal to two pulses.

13. The one-touch activation circuit as claimed in claim 12, wherein a duration of each of said two pulses generated by said timing circuit are of about 0.5 seconds.

14. The one-touch activation circuit as claimed in claim 10, wherein said timing circuit comprises a 555 integrated circuit, a capacitor and two resistors, said 555 integrated circuit being configured in conjunction with said capacitor and said resistors to operate in a stable mode thereby generating said pulsed output signal, a resistance of said resistors and a capacitance of said capacitor being selected to provide said timing.

15. The one-touch activation circuit as claimed in claim 14, wherein said cellular phone comprises a digital cellular phone, a duration of each pulse of said pulsed output signal being of about 0.5 seconds.

16. The one-touch activation circuit as claimed in claim 15, said circuit comprising a timing element adapted to limit a duration of said pulsed output signal to two pulses.
